(19) United States
(12) Patent Application Publication
(10) Pub. No.: US 2011/0226781 A1
(43) Pub. Date: Sep. 22, 2011

(54) Pressurized Fluid Tank and Method of Manufacturing Such a Tank

(76) Inventors: Daniel Walser, Villars-Sur-Glane (CH); Bruno Fragniere, Neirivue (CH)

(21) Appl. No.: 12/739,899

(22) PCT Filed: Oct. 22, 2008
(86) PCT No.: PCT/EP08/64245

§ 371 Date: Jun. 13, 2011

(30) Foreign Application Priority Data
Oct. 24, 2007 (FR) 0758545

(51) Int. Cl. F17C 1/00; B31B 1/00

(52) U.S. Cl. 220/581; 493/84

(57) ABSTRACT

A metal tank (1) for storing fluid under high pressure, comprising, along its axis (2), a plurality of adjacent compartments (10, 71, 91) separated by partitions (3), each compartment having a cylindrical wall (72), a transition zone (73) connecting each partition to the cylindrical wall, the compartments communicating with one another via at least one orifice (6) made in each partition, in which, for a given compartment, the cylindrical wall is connected via an annular weld (75) to the transition zone of the adjacent compartment.

The present invention relates to the storage of fluids under pressure. It is notably but not solely applicable to the storage of gaseous oxygen in a road vehicle, for example a fuel cell vehicle which is to carry a reserve of oxygen at high pressure.

In this field, one of the difficulties in mass-producing such vehicles is the design of the tanks because the tanks carried by these vehicles have to meet tight safety requirements in order to minimize the consequences of a knock or accidental impact. For example, when the tank is destroyed in an accident in which the vehicle is involved or when a projectile fired from a fire arm passes through the tank, the pressure of the fluid is released very suddenly. Because the storage pressures are of the order of 200 to 500 bar, the power developed by this release of pressure may be so great as to bring together the conditions required for flame cutting. One objective therefore is to minimize the power developed by the release of the internal pressure of the tank should the latter rupture. Another objective is to allow such tanks to be obtained on an industrial scale for a reasonable cost, for example at a cost that is acceptable for motor vehicle applications.

For that, the invention proposes a metal tank for storing fluid under high pressure, comprising, along its axis, a plurality of adjacent compartments separated by partitions, each compartment having a cylindrical wall, a transition zone connecting each partition to the cylindrical wall, the compartments communicating with one another via at least one orifice made in each partition, in which, for a given compartment, the cylindrical wall is connected via an annular weld to the transition zone of the adjacent compartment.

For preference, the end compartments differ from the central compartments, all the central compartments being identical to one another.

For preference, the tank has a single inlet/outlet interface situated at an inlet/outlet end of the said tank. For preference also, the partitions are domed, the concave face of the partitions facing towards the inlet/outlet end of the tank.

For preference, each partition has a single orifice, placed in the centre of the said partition, the diameter of the orifice ranging between 1 and 5 mm.

The invention also proposes a method of obtaining a metal tank for storing fluid under high pressure, the method comprising the following steps in turn:
forming basic elements comprising a cylindrical wall of round cross section, a partition comprising an orifice and fitted perpendicular to the axis of the cylindrical wall, a transition zone connecting a first end of the cylindrical wall to the partition, a second end of the cylindrical wall constituting a free edge,
juxtaposing a plurality of identical basis elements in such a way as to cause the respective axes of the cylindrical walls to coincide,
joining the said plurality of basic elements together by welding the free edge of the end of the cylindrical wall of each basic element to the transition zone of the adjacent element.

For preference, the basic elements are essentially formed by drawing.

Alternatively, the basic elements are essentially formed by the removal of material.

For preference, the plurality of basic elements are joined together by electron beam welding.

For preference, end elements are also welded to the two ends of the said plurality of basic elements, the end elements differing from the basic elements.

For preference, the transition zone of each basic element comprises a centring shoulder around which the free edge of the adjacent element is positioned.

Other features and advantages of the invention will become apparent from the description of preferred embodiments. The figures respectively depict:

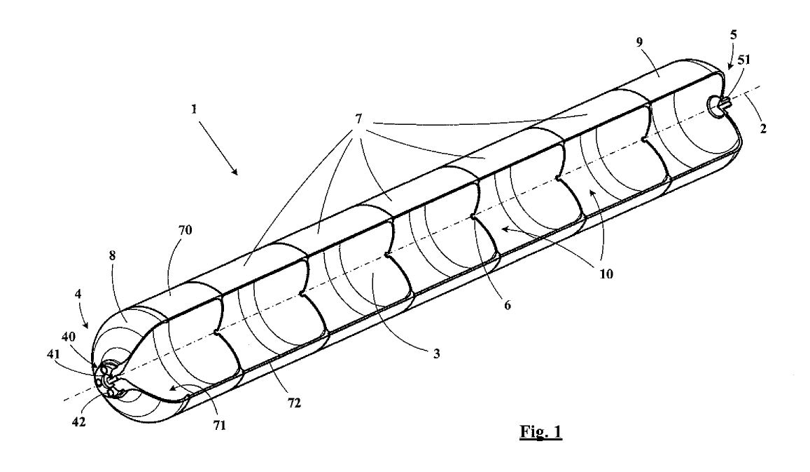

FIG. 1: a view in perspective and partial cross section of a tank according to the invention;

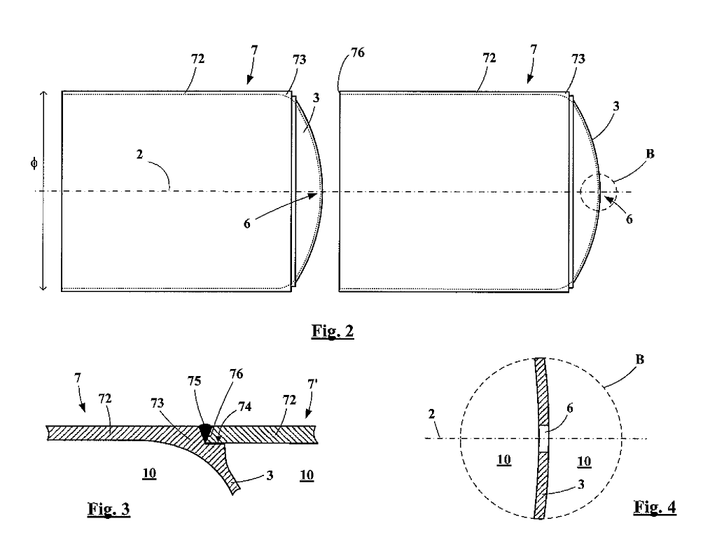

FIG. 2: a planar view of two basic elements of the tank of FIG. 1;

FIG. 3: a view in cross section on a plane containing the axis of the tank, of the detail of the connection between two tank elements of FIG. 1;

FIG. 4: a view in cross section on a plane containing the axis of the tank, of the detail of the communicating orifice between two compartments of the tank of FIG. 1;

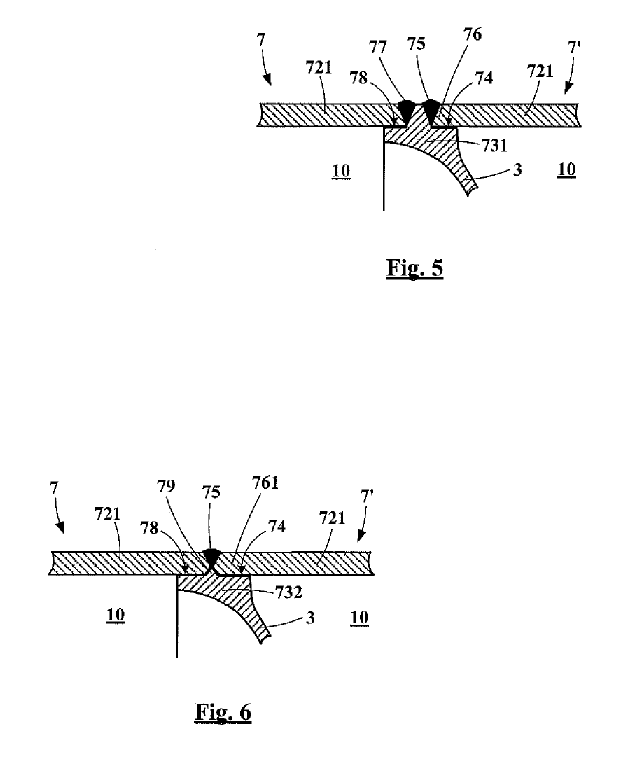

FIG. 5: a view in cross section similar to FIG. 4, of the detail of a connection according to a second embodiment of the invention;

FIG. 6: a view in cross section similar to FIGS. 4 and 5 of the detail of a connection according to a third embodiment of the invention.

Reference is made to FIG. 1 which shows in partial cross section a tank 1, of cylindrical overall shape about an axis 2. The tank has one open end 4 constituting its inlet/outlet interface 40 and one closed end 5. The inside of the tank has a plurality of partitions 3 which define a plurality of compartments 10. The adjacent compartments communicate via an orifice 6 situated at the centre of the corresponding partition. In this instance, the tank is made up of five identical basic elements 7 defining five identical central compartments 10. The end parts of the tank use special-purpose elements 8 and 9 which differ from the basic elements 7.

The closed end 5 consists of an end-cap element 9. The end compartment 91 thus defined has a volume similar to that of the central compartments. The end cap element here comprises a thread rod 51 intended to be fixed to the chassis of the vehicle via a mobile or flexible intermediate element. That will allow the closed end of the tank to move axially as a result of deformation caused by the thermal and mechanical stresses to which it is subjected. It will be appreciated that this function of holding/guiding the closed end 5 of the tank may be performed in any appropriate way, for example using sliding guidance.

The open end 4 of the tank 1 consists of an inlet/outlet element 8 which has the inlet/outlet interface 40. The inlet/outlet interface 40 comprises means of connection to the fluid circuit (see housing 41 for a seal) and also in this instance forms a means of attaching (see threaded holes 42) the tank in relation to the vehicle.

The partitions 3 are preferably domed towards the end of the tank as depicted here (the concave face facing towards the open end of the tank and of the element that the partition in question forms part of).

The tank of FIG. 1 further comprises an element 71 similar to the basic elements 7 but the tubular part of which is slightly shorter so that the inlet/outlet compartment 71 thus defined has a volume equivalent to that of the central compartments 10. However, it will be appreciated that a sixth basic element 7 could very well be used in place of this element 71 if the fact that the corresponding compartment 71 will have a volume slightly greater than that of the others can be accepted.

FIG. 2, which shows two basic elements before they are assembled with one another, clearly shows that each basic element 7 (or 71) has a partition 3 and a tubular part 72 of circular cross section of outside diameter “φ” intended to constitute the cylindrical wall of the tank. Each element is made as a single piece, preferably of a metallic and weldable material such as a stainless steel compatible with pressurized oxygen.

All the elements (basic elements and end elements) are then joined together in a sealed manner as illustrated in FIG. 3 which shows in detail one embodiment of the connection between two adjacent elements. This figure shows the transition zone 73 which links the tubular part 72 and the partition 3 of a one-piece basic element. The free edge 76 of the tubular part 72 of an adjacent element 7′ fits around a centring shoulder 74 of this transition zone. A peripheral bead of welding 75 then joins the two elements in a sealed manner. The connection illustrated here is that of two basic elements but the same type of connection can be used for the end elements 8 and 9 as may be deduced from FIG. 1. In particular, the transition zone of the inlet/outlet element 8 differs because the inlet/outlet element 8 has no partition but the connection between this element 8 and the adjacent element 70 may be made in the same way as the others.

FIG. 4 shows on a larger scale the detail B in FIG. 2. This shows the central part of the partition 3 which has the orifice 6. As described above, the orifice places the two adjacent compartments 10 in communication. While the tank is being filled, the fluid circulates through the orifice towards the right of the figure in order to fill all the compartments and place them at equal pressures. When the tank is feeding a fluid-consuming circuit, the fluid flows to the left of the figure, that is to say towards the open end 4 of the tank. The single and central orifice 6 constitutes a sonic throat which limits the rate of flow between two adjacent compartments.

The essential role played by the partitions is that of reducing the volume of fluid instantly released if the tank becomes ruptured. For preference, the partitions and the orifices need to be dimensioned in such a way that, should the tank rupture, they are able to resist a sharp drop in pressure from at least one compartment even if, in order to do so, they have to deform, including permanent (plastic) deformation. For a tank made of stainless steel, the tensile strength of which is 1100 MPa, with a diameter φ=70 mm, filled with oxygen at the customary pressure of 200 bar, it has been found that partitions 0.8 mm thick and orifices 3 mm in diameter proved entirely satisfactory. Depending on the dimensions of the tank, the diameter of the orifice may vary. For preference, it ranges between 1 and 5 mm. Alternatively, it is possible to have a plurality of smaller-diameter holes which ultimately have the same effect on the overall flowrate.

The fact that the partitions are domed towards the end of the tank allows the tank to be filled at a filling pressure that is relatively high in relation to the target storage pressure without damaging the partitions because they are able to withstand a high difference in pressure between two successive compartments (from left to right in the figures). Thus filling can be performed more rapidly. By contrast, when the fluid is then consumed by the circuit it is supplying, the difference in pressure to which the partitions are subjected is far lower (if not negligible) because the flowrate is much lower than it is during filling.

For presence, the tank is manufactured using the following method:
Basic elements and special-purpose end elements are formed, for example by the removal of material (turning, milling), by drawing or using any techniques suited to the materials chosen,
The elements that make up a tank are assembled along the axis thereof,
A definitive connection between the free edge 76 of the cylindrical wall 72 of each element and the transition zone 73 of the adjacent element is effected, for example by electron beam welding (also known as electron bombardment), laser welding or friction welding.

When it is said that the elements are obtained essentially by drawing, what that means to say is that the drawing operation gives the element its overall shape, even if further machining operations are then needed in the transition zone or on the free edge according to the precision of assembly demanded by the type of connection. It is known, for example, that a connection by electron beam welding requires relatively high precision.

FIG. 5 depicts a second embodiment of the tank according to the invention in which the elements are themselves obtained by welding (see bead of welding 77) a tube portion 721 to the shoulder 78 of the partition 3 in a similar way to that which was described above in respect of connecting of adjacent elements to one another.

FIG. 6 depicts a third embodiment of the tank according to the invention. This differs from the second embodiment in that the free edges 761 of the tube portions 721 and the transition zone 732 are configured in such a way as to allow them to be assembled and joined together using a single bead of welding 75. In this example, the free edges are chamfered at 45° and a partition 3 has an annular ridge 79, the lateral slopes of which are also inclined at 45°.

The invention has been described in a specific application to a vehicle tank but it will be appreciated that it can also be applied to the case of stationary tanks of greater or smaller capacity.

The customary pressure envisaged in motor vehicle applications is 200 bar. That corresponds, according to the standards currently in force, to a proof pressure of 300 bar and a tensile strength in excess of 450 bar.

One advantage of the invention is that the length of the tank is dependent only on the number of basic elements employed.

1. A metal tank for storing fluid under high pressure, comprising, along its axis, a plurality of adjacent compartments separated by partitions, each compartment having a cylindrical wall, a transition zone connecting each partition to the cylindrical wall, the compartments communicating with one another via at least one orifice made in each partition, in which, for a given compartment, the cylindrical wall is connected via an annular weld to the transition zone of the adjacent compartment.

2. The tank according to claim 1, wherein the end compartments differ from the central compartments, all the central compartments being identical to one another.

3. The tank according to claim 1, comprising a single inlet/outlet interface situated at an inlet/outlet end of the said tank.

4. The tank according to claim 3, wherein the partitions are domed, the concave face of the partitions facing towards the inlet/outlet end of the tank.

5. The tank according to claim 1, wherein each partition has a single orifice, placed in the centre of said partition, the diameter of the orifice ranging between 1 and 5 mm.

6. A method of manufacturing a metal tank for storing fluid under high pressure, the method comprising the following steps in turn:
forming basic elements comprising a cylindrical wall of round cross section, a partition comprising an orifice and fitted perpendicular to the axis of the cylindrical wall, a transition zone connecting a first end of the cylindrical wall to the partition, a second end of the cylindrical wall constituting a free edge;
juxtaposing a plurality of identical basic elements in such a way as to cause the respective axes of the cylindrical walls to coincide; and
joining the said plurality of basic elements together by welding the free edge of the end of the cylindrical wall of each basic element to the transition zone of the adjacent element.

7. The method according to claim 6, wherein the basic elements are essentially formed by drawing.

8. The method according to claim 6, wherein the basic elements are essentially formed by the removal of material.

9. The method according to claim 6, wherein the plurality of basic elements are joined together by electron beam welding.

10. The method according to claim 6, wherein end elements are also welded to the two ends of the said plurality of basic elements, the end elements differing from the basic elements.

11. The method according to claim 6, wherein the transition zone of each basic element comprises a centring shoulder around which the free edge of the adjacent element is positioned.
